(19) United States
(12) Patent Application Publication
(10) Pub. No.: US 2020/0153114 A1
(43) Pub. Date: May 14, 2020

(54) PLANAR ARRAY ANTENNA AND WIRELESS MODULE

(71) Applicant: FUJIKURA LTD., Tokyo (JP)

(72) Inventor: Hideyuki Wada, Sakura-shi (JP)

(73) Assignee: FUJIKURA LTD., Tokyo (JP)

(21) Appl. No.: 16/629,363

(22) PCT Filed: Feb. 28, 2018
(86) PCT No.: PCT/JP2018/007488

§ 371 Date: Jan. 8, 2020

(30) Foreign Application Priority Data
Jul. 14, 2017 (JP) 2017-138522

(51) Int. Cl. H01Q 21/06; H01Q 13/08; H01Q 1/38

(52) U.S. Cl. CPC H01Q 21/065; H01Q 1/38; H01Q 13/08

(57) ABSTRACT

A planar array antenna 20 includes: a dielectric substrate; a conductive ground layer 37 formed on one surface of the dielectric substrate; a plurality of serial-type radiation element rows 41 formed on another surface of the dielectric substrate; and a parallel feed line that is formed on the other surface of the dielectric substrate and supplies high-frequency electric power between a feed end point 45s on the other surface of the dielectric substrate and the serial-type radiation element rows 41. The parallel feed line 45 branches from the feed end point 45s to the radiation elements 42 at ends of the serial-type radiation element rows closest to the feed end point 45s, and connects the feed end point 45s to the radiation elements 42, and all of the serial-type radiation element rows 41 an identical path length from the feed end point 45s to each of the radiation elements 42.

### TECHNICAL FIELD

The present disclosure relates to a planar array antenna and a wireless module used in a frequency band of a high frequency such as a microwave and a millimeter wave.

### BACKGROUND ART

Patent Literatures 1 to 3 disclose a microstrip array antenna. Particularly, Patent Literatures 1 and 3 disclose both of a microstrip array antenna employing a serial feed system and a microstrip array antenna employing a parallel feed system.

Patent Literature 4 discloses a slot array antenna that supplies electric power using a waveguide. The waveguide does not transmit a signal wave using a conductive wiring line. Thus, an electric circuit (amplifier) that amplifies a signal wave cannot be provided at a halfway portion of the waveguide.

### CITATION LIST

### Patent Literature

Patent Literature 1: Japanese Patent Application Publication No. 2017-34644

Patent Literature 2: Japanese Patent Application Publication No. 2014-212361

Patent Literature 3: Japanese Patent Application Publication No. 2003-174318

Patent Literature 4: Japanese Patent Application Publication No. 2014-195203

### SUMMARY OF INVENTION

### Technical Problem

In a case of the microstrip array antennas described in Patent Literatures 1 to 3, even if the number of radiation elements is increased to achieve high gain, a path length of a microstrip line feed line increases, and accordingly a transmission loss in the feed line increases. As a result, the antennas cannot achieve high gain.

Particularly, in a case of the microstrip array antenna employing the parallel feed system described in Patent Literature 1 (see FIG. 16 in Patent Literature 1), when the number of radiation elements increases, a feed line extremely increases in length, and a transmission loss in the feed line cannot be ignored. On the other hand, in a case of the microstrip array antenna employing the parallel feed system described in Patent Literature 3 (see FIG. 7 in Patent Literature 3), a large number of radiation elements cannot be disposed because a feed line gets in the way, and even in if a large number of radiation elements can be disposed, a transmission loss in the feed line increases.

Further, in a case of a microstrip array antenna, directivity of an antenna is determined according to positions of radiation elements and a feed system, and thus in order to transmit and/or receive radio waves over a long distance, the antenna needs to be installed in an appropriate direction. To achieve this, directivity of the antenna needs to be appropriately set.

Thus, the present disclosure has been achieved in view of the circumstances described above. An object of the present disclosure is to achieve a high gain of an antenna, and to be able to appropriately set directivity of the antenna.

### Solution to Problem

A main aspect of the present disclosure for achieving an object described above is a planar array antenna comprising: a dielectric substrate; a conductive ground layer formed on one surface of the dielectric substrate; a plurality of serial-type radiation element rows formed on another surface of the dielectric substrate; and a parallel feed line that is formed on the other surface of the dielectric substrate and supplies high-frequency electric power between a feed end point on the other surface of the dielectric substrate and the plurality of serial-type radiation element rows, the serial-type radiation element rows each including a plurality of radiation elements, the plurality or radiation elements being aligned linearly at regular intervals and connected in series, the parallel feed line branching into the number of the serial-type radiation element rows from the feed endpoint to the radiation elements, at ends of the serial-type radiation element rows closest to the feed end point, in the plurality of radiation elements in the serial-type radiation element rows, and connecting the feed end point to the radiation elements at the ends closest to the feed end point, all of the plurality of serial-type radiation element rows having an identical pitch between the plurality of radiation elements, and all of the plurality of serial-type radiation element rows having an identical path length, along the parallel feed line, from the feed end point to each of the radiation elements at the ends closest to the feed end point.

Other features of the present disclosure will become apparent from descriptions of the present specification and of the accompanying drawings.

### Advantageous Effects of Invention

With the present disclosure, a high gain of a planar array antenna can be achieved. Further, directivity of the planar array antenna can be appropriately set.

### BRIEF DESCRIPTION OF DRAWINGS

FIG. 1 is a plan view of a wireless module according to a first embodiment.

FIG. 2 is a side view of the wireless module according to the first embodiment.

FIG. 3 is a cross-sectional view of a planar array antenna according to the first embodiment.

FIG. 4 is an enlarged plan view of a main part of the planar array antenna according to the first embodiment.

FIG. 5 is a diagram illustrating an internal structure of a wireless device using the wireless module according to the first embodiment.

FIG. 6 is a diagram illustrating an internal structure of a wireless device using the wireless module according to the first embodiment.

FIG. 7 is an enlarged plan view of a main part of a planar array antenna according to a modification example of the first embodiment.

FIG. 8 is an enlarged plan view of a main part of a planar array antenna according to a modification example of the first embodiment.

FIG. 9 is an enlarged plan view of a main part of a planar array antenna according to a modification example of the first embodiment.

FIG. 10 is a plan view of a wireless module according to a second embodiment.

FIG. 11 is a cross-sectional view of a planar array antenna according to the second embodiment.

FIG. 12 is an enlarged plan view of a main part of the planar array antenna according to the second embodiment.

FIG. 13 is an enlarged plan view of a main part of a planar array antenna according to a modification example of the second embodiment.

FIG. 14 is an enlarged plan view of a main part of a planar array antenna according to a modification example of the second embodiment.

FIG. 15 is an enlarged plan view of a main part of a planar array antenna according to a modification example of the second embodiment.

### DESCRIPTION OF EMBODIMENTS

At least the following matters are made clear from the following description and the drawings.

A planar array antenna will become apparent, which comprises: a dielectric substrate; a conductive ground layer formed on one surface of the dielectric substrate; a plurality of serial-type radiation element rows formed on another surface of the dielectric substrate; and a parallel feed line that is formed on the other surface of the dielectric substrate and supplies high-frequency electric power between a feed end point on the other surface of the dielectric substrate and the plurality of serial-type radiation element rows, the serial-type radiation element rows each including a plurality of radiation elements, the plurality or radiation elements being aligned linearly at regular intervals and connected in series, the parallel feed line branching into the number of the serial-type radiation element rows from the feed endpoint to the radiation elements, at ends of the serial-type radiation element rows closest to the feed end point, in the plurality of radiation elements in the serial-type radiation element rows, and connecting the feed end point to the radiation elements at the ends closest to the feed endpoint, all of the plurality of serial-type radiation element rows having an identical pitch between the plurality of radiation elements, and all of the plurality of serial-type radiation element rows having an identical path length, along the parallel feed line, from the feed end point to each of the radiation elements at the ends closest to the feed end point.

In such a planar array antenna, all of the plurality of serial-type radiation element rows have an identical path length from the feed end point to each of the radiation elements, at the ends of the radiation element rows closest to the feed end point, and thus all of the serial-type radiation element rows have also an identical feed phase. Therefore, directivity of the planar array antenna can be appropriately set according to arrangement of the serial-type radiation element rows.

Further, the parallel feed line connects the feed end point to the radiation elements at the ends of the radiation element rows closest to the feed end point, and thus a path length from the feed end point to each of the radiation elements can be minimized. Accordingly, transmission loss in the parallel feed line can be reduced, and a high gain of the planar array antenna can be achieved.

The plurality of serial-type radiation element rows are arranged in parallel, and the radiation elements at the ends closest thereto in the plurality of serial-type radiation element rows are arranged in a line in a direction perpendicular to a direction of the serial-type radiation element rows.

In this way, a direction of the maximum radiation intensity of the planar array antenna can be set so as to be inclined toward the feed end point with respect to a normal direction of the dielectric substrate.

The parallel feed line is disposed within a region between the feed end point and the radiation elements at the ends closest thereto in the plurality of serial-type radiation element rows.

In this way, a path length from the feed end point to each of the radiation elements can be minimized. Accordingly, transmission loss in the parallel feed line can be reduced, and a high gain of the planar array antenna can be achieved.

An entire shape of the plurality of serial-type radiation element rows is line-symmetric with respect to a symmetrical line, the symmetrical line being parallel to the direction of the serial-type radiation element rows and passing through the feed end point.

In this way, the direction of the maximum radiation intensity of the planar array antenna can be set so as not to be inclined around the symmetrical line with respect to a plane that passes through the symmetrical line and is perpendicular to the dielectric substrate.

When the plurality of serial-type radiation element rows are divided into two groups, the plurality of serial-type radiation element rows included in a first group are arranged in parallel, and the radiation elements at the ends closest thereto in the plurality of serial-type radiation element rows in the first group are arranged in a line in a direction perpendicular to a direction of the serial-type radiation element row in the first group, the plurality of serial-type radiation element rows included in a second group are arranged in parallel so as to be parallel to the direction of the serial-type radiation element rows in the first group, and the radiation elements at the ends closest thereto in the plurality of serial-type radiation element rows in the second group are arranged in a line in a direction perpendicular to a direction of the serial-type radiation element rows in the second group, and the plurality of serial-type radiation element rows in the first group and the plurality of serial-type radiation element rows in the second group are arranged in the direction of their rows.

In this way, the direction of the maximum radiation intensity of the planar array antenna can be set to the normal direction of the dielectric substrate.

The feed end point is disposed within a region between the plurality of serial-type radiation element rows in the first group and the plurality of serial-type radiation element rows in the second group.

The parallel feed line is disposed within the region.

In this way, transmission loss in the parallel feed line can be reduced, and a high gain of the planar array antenna can be achieved.

An entire shape of the plurality of serial-type radiation element rows is line-symmetric with respect to a symmetrical line, the symmetrical line being perpendicular to a direction of the serial-type radiation element rows and passing through the feed end point.

An entire shape of the plurality of serial-type radiation element rows is line-symmetric with respect to a symmetrical line, the symmetrical line being parallel to the direction of the serial-type radiation element rows and passing through the feed end point.

An entire shape of the plurality of serial-type radiation element rows has two-fold rotational symmetry around the feed end point.

In this way, the direction of the maximum radiation intensity of the planar array antenna can be set to the normal direction of the dielectric substrate.

When the plurality of serial-type radiation element rows are divided into four groups, the plurality of serial-type radiation element rows included in a first group are arranged in parallel, and the radiation elements at the ends closest thereto in the plurality of serial-type radiation element rows in the first group are aligned in a direction perpendicular to a direction of the serial-type radiation element rows in the first group, the plurality of serial-type radiation element rows included in a second group are arranged in parallel so as to be parallel to the direction of the serial-type radiation element rows in the first group, and the radiation elements at the ends closest thereto in the plurality of serial-type radiation element rows in the second group are aligned in a direction perpendicular to a direction of the serial-type radiation element rows in the second group, the plurality of serial-type radiation element rows in the first group and the plurality of serial-type radiation element rows in the second group are arranged in the direction of their rows, the plurality of serial-type radiation element rows included in a third group are arranged in parallel so as to be perpendicular to the direction of the serial-type radiation element rows in the first group, and the radiation elements at the ends closest thereto in the plurality of serial-type radiation element rows in the third group are aligned in a direction perpendicular to a direction of the serial-type radiation element rows in the third group, the plurality of serial-type radiation element rows included in a fourth group are arranged in parallel so as to be parallel to the direction of the serial-type radiation element rows in the third group, and the radiation elements at the ends closest thereto in the plurality of serial-type radiation element rows in the fourth group are aligned in a direction perpendicular to a direction of the serial-type radiation element rows in the fourth group, the plurality of serial-type radiation element rows in the third group and the plurality of serial-type radiation element rows in the fourth group are arranged in the direction of their rows, and a region between the plurality of serial-type radiation element rows in the first group and the plurality of serial-type radiation element rows in the second group is disposed between the plurality of serial-type radiation element rows in the third group and the plurality of serial-type radiation element rows in the fourth group.

In this way, the direction of the maximum radiation intensity of the planar array antenna can be set to the normal direction of the dielectric substrate. Further, the number of the radiation elements can increase, and a high gain of the planar array antenna can be achieved.

The feed end point is disposed within the region.

The parallel feed line is disposed within the region.

In this way, transmission loss in the parallel feed line can be reduced, and a high gain of the planar array antenna can be achieved.

An entire shape of the plurality of serial-type radiation element rows is line-symmetric with respect to a symmetrical line, the symmetrical line being parallel to the direction of the serial-type radiation element rows in the first group and passing through the feed end point.

An entire shape of the plurality of serial-type radiation element rows is line-symmetric with respect to a symmetrical line, the symmetrical line being parallel to the direction of the serial-type radiation element rows in the third group and passing through the feed end point.

An entire shape of the plurality of serial-type radiation element rows has four-fold rotational symmetry around the feed end point.

In this way, the direction of the maximum radiation intensity of the planar array antenna can be set to the normal direction of the dielectric substrate.

The planar array antenna further comprises a plurality of amplifiers that are connected to the parallel feed circuit at a halfway portion thereof from the feed end point to the radiation elements at the ends closest to the feed end point, and amplify signals passing through the parallel feed circuit.

Preferably, the plurality of amplifiers are disposed at positions that are point-symmetric with respect to the feed end point.

In this way, long distance transmission of a radio wave can be achieved by amplifying a signal.

A wireless module will become apparent which comprises: the planar array antenna; and an electronic component surface-mounted on the planar array antenna, wherein a feed terminal of the electronic component is connected to the feed end point.

In this way, a transmission loss between the electronic component and the parallel feed line can be reduced.

### Embodiments

Embodiments of the present disclosure are described below with reference to the drawings. Note that, although various limitations that are technically preferable for carrying out the disclosure are imposed on the embodiments to be described below, the scope of the present disclosure is not to be limited to the embodiments below and illustrated examples.

### First Embodiment

1. Overall of Wireless Module

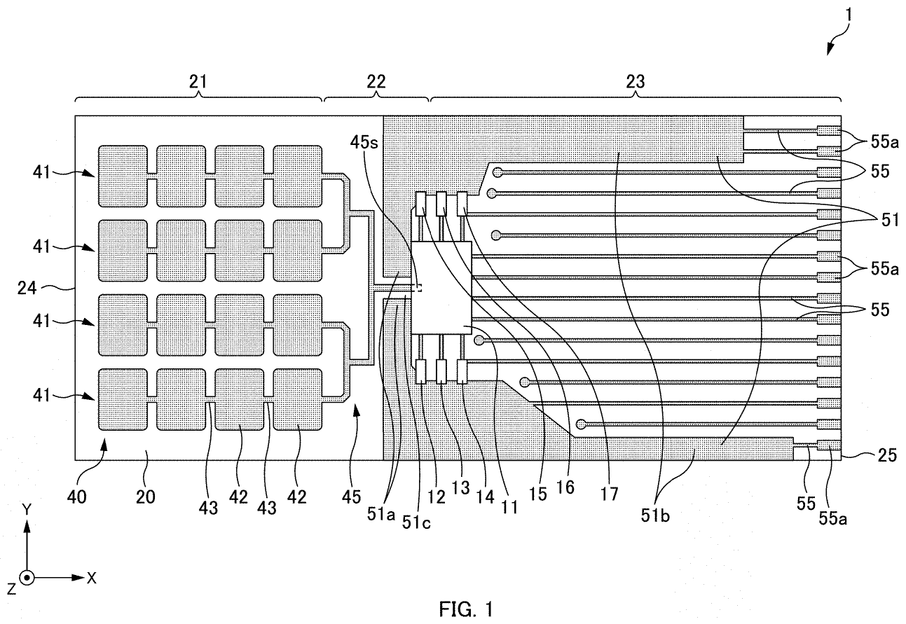

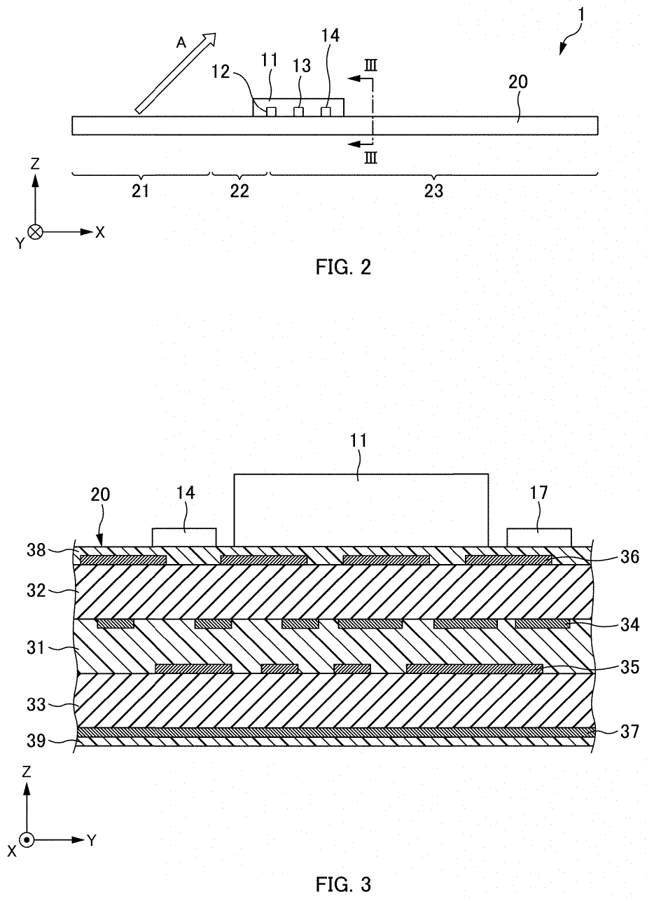

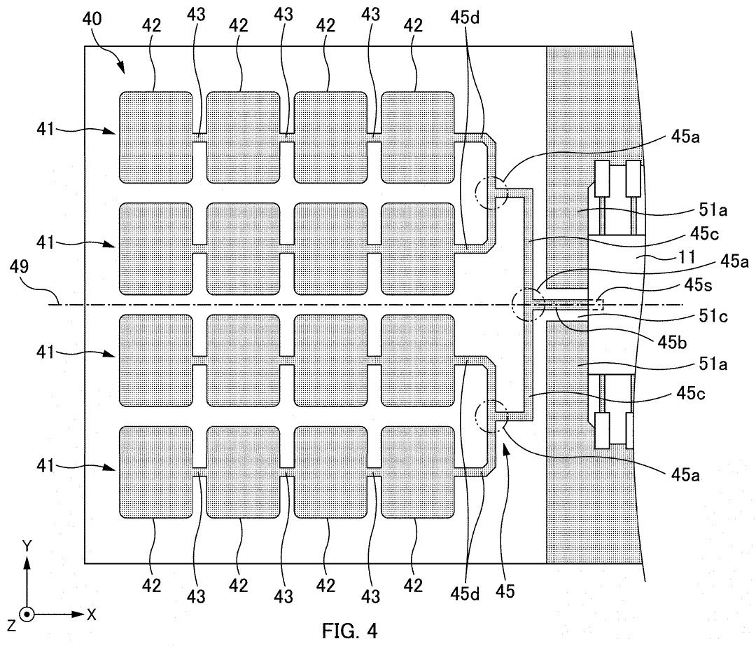

FIG. 1 is a plan view of a wireless module 1. FIG. 2 is a side view of the wireless module 1. FIG. 3 is a cross-sectional view taken along III-III illustrated in FIG. 2. FIG. 4 is an enlarged plan view of a main part of the wireless module 1. In the drawings, an X axis, a Y axis, and a Z axis are illustrated as auxiliary lines or symbols representing directions. The X axis, the Y axis, and the Z axis are orthogonal to each other.

As illustrated in FIGS. 1 and 2, the wireless module 1 is a module that transmits, receives, or transmits and receives a radio wave in a frequency band of a microwave or a millimeter wave. The wireless module 1 includes a planar array antenna 20, and electronic components 11 to 17 that are surface-mounted on the planar array antenna 20. Here, the X axis illustrated in FIGS. 1 to 3 is parallel to long sides of the planar array antenna 20 having a rectangular shape, the Y axis is parallel to short sides 24 and 25 of the planar array antenna 20, and the X axis and the Y axis are parallel to a front surface and a back surface of the planar array antenna 20.

2. Planar Array Antenna

As illustrated in FIG. 3, the planar array antenna 20 is a multilayer wiring board. The planar array antenna 20 includes a dielectric adhesive layer 31, dielectric base materials 32 and 33, conductive pattern layers 34, 35, and 36, a conductive ground layer 37, and passivation films 38 and 39.

The dielectric base material 32 having a thin plate shape and the dielectric base material 33 having a thin plate shape are bonded together with the dielectric adhesive layer 31. In this way, the dielectric base material 32, the dielectric adhesive layer 31, and the dielectric base material 33 are laminated in this order, and a laminated body thereof constitutes a dielectric substrate. The dielectric base materials 32 and 33 are made of, for example, resin (such as a liquid crystal polymer, a polyimide, and polyethylene terephthalate), fiber-reinforced resin (such as glass cloth epoxy resin), fluoropolymer, or ceramic. The dielectric adhesive layer 31 is made of, for example, epoxy resin.

The conductive pattern layer 34 is formed between the dielectric base material 32 and the dielectric adhesive layer 31, and the conductive pattern layer 35 is formed between the dielectric base material 33 and the dielectric adhesive layer 31. The conductive pattern layers 34 and 35 are coated with the dielectric adhesive layer 31 by bonding the dielectric base material 32 to the dielectric base material 33 with the dielectric adhesive layer 31. Here, the conductive pattern layer 34 is acquired by shape-processing (patterning) a conductive layer (such as a metal plating layer) formed on a surface of the dielectric base material 32 on the dielectric adhesive layer 31 side by a photolithography method, an etching method, or the like. The same also applies to the conductive pattern layer 35.

The conductive pattern layer 36 is formed on a surface of the dielectric base material 32 on a side opposite to the dielectric adhesive layer 31. Furthermore, the passivation film 38 is formed on the surface so as to coat the conductive pattern layer 36. The conductive pattern layer 36 is acquired by shape-processing a conductive layer formed on the dielectric base material 32 by a photolithography method, an etching method, and the like. The conductive pattern layer 36 will be described later in detail.

The conductive ground layer 37 is formed on a surface of the dielectric base material 33 on a side opposite to the dielectric adhesive layer 31. Furthermore, the passivation film 39 is formed on the surface so as to coat the conductive ground layer 37. The conductive ground layer 37 is acquired by shape-processing a conductive layer formed on the dielectric base material 33 by a photolithography method, an etching method, or the like. Note that the conductive ground layer 37 may be a layer formed on the entire surface of the dielectric base material 33 on the side opposite to the dielectric adhesive layer 31 without patterning.

The passivation films 38 and 39 are formed of an insulating and dielectric material. The passivation film 38 protects the dielectric base material 32 and the conductive pattern layer 36, and the passivation film 39 protects the dielectric base material 33 and the conductive ground layer 37.

3. Electronic Component

As illustrated in FIGS. 2 and 3, the electronic components 11 to 17 are surface-mounted on the planar array antenna 20 as described above, in other words, on the surface of the dielectric base material 32 on the side opposite to the dielectric adhesive layer 31. The electronic component 11 is a so-called radio frequency integrated circuit (RFIC), and is configured with an integrated circuit (IC) that includes a reception circuit, a transmission circuit, both of them, or the like. Note that the reception circuit included in the electronic component 11 is configured with, for example, a tuning circuit, a demodulation circuit, an amplifier, and the like, and the transmission circuit included in the electronic component 11 is configured with, for example, an oscillation circuit, a modulation circuit, an amplifier, and the like.

A terminal of the electronic component 11 is connected to the conductive pattern layer 36 by, for example, a ball grid array (BGA) method or a land grid array (LGA) method by using solder and the like. The electronic components 12 to 17 each are, for example, a resistor, a capacitor, an inductor (coil), or an oscillator. Each terminal of the electronic components 12 to 17 is connected to the conductive pattern layer 36 by using solder and the like.

Here, in order to describe details of positions where the electronic components 11 to 17 are mounted, the planar array antenna 20 is divided into three rectangular regions 21 to 23 as illustrated in FIGS. 1 and 2. The region 21 is a rectangular region on one short side 24 side, the region 23 is a rectangular region on the other short side 25 side, and the region 22 is a rectangular region between the region 21 and the region 23. Hereinafter, the region 21 may also be referred to as an antenna formation region 21, the region 22 may also be referred to as a feed line formation region 22, and the region 23 may also be referred to as a signal line formation region 23.

The electronic components 11, 13, 14, 16, and 17 are mounted closer to the feed line formation region 22 in the signal line formation region 23. Further, the electronic components 12 and 15 are mounted closer to the signal line formation region 23 in the feed line formation region 22. The electronic components 11 to 17 are disposed so as to be close to each other. The electronic component 11 partially protrudes from the signal line formation region 23 toward the feed line formation region 22.

4. Conductive Pattern Layer of Planar Array Antenna

As described above, the conductive pattern layer 36 is patterned (shape-processed), and thus the conductive pattern layer 36 will be described with reference to FIGS. 1 and 4. In FIGS. 1 and 4, the conductive pattern layer 36 is drawn with a dotted pattern, and also the passivation film 38 is omitted, in order to make the conductive pattern layer 36 easier to see.

By patterning the conductive pattern layer 36, the conductive pattern layer 36 is provided with 2ⁿ rows (n is an integer of one or more) of serial-type radiation element rows 41, a parallel feed line 45 of 2ⁿ distributions, a pair of conductive ground portions 51, and a large number of wiring lines 55. In the examples illustrated in FIGS. 1 and 4, n is two, and the number of the serial-type radiation element rows 41 is four, but the number of the serial-type radiation element rows 41 maybe greater if the antenna formation region 21 is wider than that illustrated in FIGS. 1 and 4. As the number of the serial-type radiation element rows 41 is greater, a gain of an antenna increases. Note that a “serial-type radiation element row” is abbreviated as the “element row” in the following description.

The conductive ground portions 51 in a pair are respectively formed, with a space therebetween, on two side portions in the Y direction of the signal line formation region 23, and portions 51a of the conductive ground portion 51 extend from the signal line formation region 23 to the feed line formation region 22. A gap 51c between the portions 51a, of the conductive ground portions 51, extending to the feed line formation region 22 is narrower than a gap between remainders 51b. Note that the electronic components 11 to 17 are disposed closer to the short side 25 of the planar array antenna 20 than the portions 51a of the conductive ground portions 51 extending to the feed line formation region 22 are, and are also disposed between the remainders 51b.

The conductive ground portion 51 is connected to the terminals of the electronic components 11 to 17, and a reference potential (ground potential) is applied to the terminals of the electronic components 11 to 17 from the conductive ground portion 51. Further, the conductive ground portion 51 is connected to the conductive ground layer 37 (see FIG. 3) through a via hole, and the reference potential is applied to the conductive ground layer 37 from the conductive ground portion 51.

The wiring lines 55 are formed in the signal line formation region 23 so as to be routed in a long-side direction (X direction) of the planar array antenna 20 from the short side 25 of the planar array antenna 20 toward the feed line formation region 22. End portions 55a of the wiring lines 55 are formed in an island shape so as to have a width greater than that of other portions, and are aligned along the short side 25 of the planar array antenna 20. The end portions 55a of the wiring lines 55 are connecting terminals. The end portions 55a of the wiring lines 55 are exposed without being covered with the passivation film 38, and are connected to the terminals of another device when the wireless module 1 is mounted on the device.

Some of the wiring lines 55 are routed from the short side 25 of the planar array antenna 20 to the conductive ground portion 51, and are connected to the conductive ground portion 51. Others are routed, between the pair of conductive ground portions 51, from the short side 25 of the planar array antenna 20 to the vicinity of the electronic components 11 to 17, and connected to the terminals of the electronic components 11 to 17. Some of the wiring lines 55 connected to the terminals of the electronic components 11 to 17 are directly connected to the terminals of the electronic components 11 to 17, and others are connected to the terminals of the electronic components 11 to 17 via a via hole, the conductive pattern layers 34 and 35, and the like. The wiring lines 55 connected to the terminals of the electronic components 11 to 17 include a power supply line that supplies a power supply voltage to the electronic component 11, a clock line that supplies an operation clock to the electronic component 11, a signal line that supplies various signals to the electronic components 11 to 17, and the like.

In the antenna formation region 21, 2ⁿ rows of the element rows 41 are formed. Each of the element rows 41 includes a plurality of patch-type radiation elements 42 and direct-coupled feed lines 43. In the examples illustrated in FIGS. 1 and 4, the number of the radiation elements 42 included in one row of the element rows 41 is four, but the number thereof may be two to three, or may be five or more. As the number of the radiation elements 42 included in the element row 41 increases, a gain of an antenna increases. The number of the radiation elements 42 is preferably increased as much as possible according to the size and shape of the antenna formation region 21.

In any of the element rows 41, the plurality of radiation elements 42 are aligned linearly at regular intervals in the long-side direction (X direction) of the planar array antenna 20. The radiation elements 42 are connected in series using the direct-coupled feed lines 43 provided between the radiation elements 42 immediately adjacent to each other.

The above-described 2ⁿ rows of the element rows 41 are arranged in parallel at regular intervals in a short-side direction (Y direction) of the planar array antenna 20, and thus the radiation elements 42 are arranged in a grid pattern as the entire 2ⁿ rows of the element rows 41.

The radiation elements 42, at ends of the element rows 41 closest to a feed end point 45s of the parallel feed line (feed terminal of the electronic component 11), in the respective element rows 41 are aligned in terms of their positions in the X direction. In other words, the radiation elements 42, at the ends closest to the feed end point 45s of the parallel feed line 45, in the respective element rows 41 are arranged in a line in a direction (Y direction) perpendicular to a direction (X direction) of the element rows 41.

All the intervals between the element rows 41 adjacent to each other (interval between the radiation elements 42 adjacent to each other in the Y direction) are identical. An interval between the radiation elements 42 adjacent to each other in the Y direction and an interval between the radiation elements 42 adjacent to each other in the X direction may be identical or may be different. Hereinafter, the element rows 41 being arranged in parallel is referred to as a radiation element array 40.

The radiation element array 40 is formed to be line-symmetric with respect to a symmetrical line 49. The symmetrical line 49 is parallel to the direction (X direction) of the element row 41 and passes through the feed end point 45s (i.e., the feed terminal of the electronic component 11) of the parallel feed line 45 described later. Since the number of the element rows 41 is an even number, none of the element rows 41 is disposed on the symmetrical line 49.

In order to allow the radiation element array 40 to function as a microstrip antenna, the conductive ground layer 37 (see FIG. 3) is formed so as to spread in the entire antenna formation region 21, and the dielectric adhesive layer 31 and the dielectric base materials 32 and 33 are interposed between the conductive ground layer 37 and the radiation element 42. Further, the conductive pattern layers 34 and 35 do not extend to the antenna formation region 21.

The parallel feed line 45 is formed in the feed line formation region 22. The parallel feed line 45 connects between 2ⁿ rows of the element rows 41 and the feed terminal of the electronic component 11. A connecting section of the parallel feed line 45 and the feed terminal of the electronic component 11 corresponds to the feed end point 45s of the parallel feed line 45.

When a transmission circuit is incorporated in the electronic component 11, the electronic component 11 supplies high-frequency electric power to the parallel feed line 45 through the feed terminal and the feed end point 45s. Then, the parallel feed line 45 divides and transmits, to 2ⁿ rows of the element rows 41, the high-frequency electric power supplied to the feed endpoint 45s by the electronic component 11.

On the other hand, when a reception circuit is incorporated in the electronic component 11, the parallel feed line 45 synthesizes high-frequency electric power generated in 2ⁿ rows of the element rows 41 by reception of a radio wave, and transmits the high-frequency electric power to the electronic component 11 through the feed end point 45s and the feed terminal.

The parallel feed line 45 includes n stages of T-type distribution portions 45a, and is formed in a shape of a tree branching into 2ⁿ from the feed end point 45s to the element rows 41 (particularly, the radiation elements 42 at the ends closest to the feed end point 45s of the parallel feed line 45) using the distribution portion 45a. Note that, in a case of reception of a radio wave, the distribution portion 45a is a synthesizing portion.

The number of the distribution portions 45a in an m-th stage (m is a given integer from one to n) from the feed terminal of the electronic component 11 is 2^{m-1}.

The distribution portion 45a in a first stage from the electronic component 11 is connected to the feed terminal of the electronic component 11 via a feed line 45b. A connecting section of the feed line 45b and the feed terminal of the electronic component 11 is the feed end point 45s of the parallel feed line 45. The feed line 45b extends in the X direction in the gap 51c between the portions 51a of the conductive ground portions 51 extending to the feed line formation region 22, and is routed from the distribution portion 45a in the first stage to the feed end point 45s.

The distribution portions 45a in adjacent stages are connected using a feed line 45c.

The distribution portion 45a in an n-th stage from the electronic component 11 is connected to the element rows 41 (particularly, the radiation elements 42 at the ends closest to the feed end point 45s of the parallel feed line 45) via a feed line 45d.

In a case of transmission, each distribution portion 45a divides high-frequency electric power transmitted from the electronic component 11 or the distribution portion 45a in a previous stage into two, and transmits the high-frequency electric power to the distribution portions 45a in a subsequent stage or the element rows 41 (particularly, the radiation elements 42 at the ends closest to the feed end point 45s of the parallel feed line 45). In a case of reception, each distribution portion 45a synthesizes high-frequency electric power transmitted from the distribution portions 45a in a subsequent stage or the element rows 41 (particularly, the radiation elements 42 at the ends closest to the feed end point 45s of the parallel feed line 45), and transmits the high-frequency electric power to the electronic component 11 or the distribution portion 45a in a previous stage.

The parallel feed line 45 as described above is formed to be line-symmetric with respect to the symmetrical line 49. Further, all of the element rows 41 have an identical path length (electrical length) from each of the radiation elements 42 at the ends closest to the feed end point 45s of the parallel feed line 45 to the feed end point 45s of the parallel feed line 45 through the parallel feed line 45. Therefore, electric power in the same phase is supplied to all of the radiation elements 42 at the ends closest to the feed end point 45s of the parallel feed line 45.

Further, since the radiation element array 40 is formed to be line-symmetric with respect to the symmetrical line 49, electric power in the same phase is supplied to the radiation elements 42 arranged in positions symmetric to each other with respect to the symmetrical line 49. Furthermore, electric power in the same phase is supplied to the radiation elements 42 that are disposed in positions in the same order, from the parallel feed line 45.

Since the element rows 41 adopt a serial feed system, the radiation elements 42 included in the same element row 41 have a phase of electric supply that is delayed as the radiation element 42 becomes distant from the parallel feed line 45. Thus, as shown an arrow A in FIG. 2, the radiation element array 40 has radio wave directivity having the maximum radiation intensity in a direction inclined toward the electronic component 11 with respect to a normal direction of the planar array antenna 20. An angle of maximum radiation intensity of the radiation element array 40 with reference to a normal line of the planar array antenna 20 is larger than 0° and smaller than 90°. Even when an angle of the maximum radiation intensity of the radiation element array 40 is inclined toward the electronic components 11 to 17 with respect to the normal direction of the planar array antenna 20 as indicated by the arrow A, a radio wave interference of the electronic components 11 to 17 is not caused because the electronic components 11 to 17 are thin and a distance from the element row 41 to the electronic component 11 is long.

Note that, in order to allow the parallel feed line 45 to function as a microstrip-line-type signal transmission path, the conductive ground layer 37 (see FIG. 3) is formed so as to spread in the entire feed line formation region 22, and the dielectric adhesive layer 31 and the dielectric base materials 32 and 33 are interposed between the conductive ground layer 37 and the parallel feed line 45. Further, the conductive pattern layers 34 and 35 do not extend to the feed line formation region 22.

5. Effects

The wireless module 1 configured as described above has the following effects and advantages.

(1) The radiation element array 40 includes the plurality of radiation elements 42 arranged in a grid pattern in the X direction and the Y direction. Thus, the number of the radiation elements 42 is large, and the area of the radiation element array 40 is large. Accordingly, it is possible to achieve a high gain of the radiation element array 40 and long distance transmission of a radio wave.

(2) All of the element rows 41 have an identical path length from the radiation elements 42, closest to the feed end point 45s of the parallel feed line 45, in the element rows 41 to the feed end point 45s of the parallel feed line (feed terminal of the electronic component 11). Furthermore, all of the element rows 41 have an identical pitch in the X direction of the element rows 41. Thus, electric power in the same phase is supplied to the radiation elements 42 disposed in positions in the same order, from the parallel feed line 45. Thus, all of the element rows 41 have the same direction of the maximum radiation intensity, and a high gain of the radiation element array 40 can be achieved. Further, the angle of the maximum radiation intensity of the radiation element array 40 can be inclined with respect to the normal direction of the planar array antenna 20.

(3) All of the distribution portions 45a of the parallel feed line 45 are disposed in the region between the radiation element array 40 and the electronic component 11. Thus, a path length from the radiation element 42 to the feed end point can be minimized, and a transmission loss in the parallel feed line 45 can be reduced.

(4) The parallel feed line 45 is connected to the radiation elements 42, closest to the feed end point 45s of the parallel feed line 45, in the element rows 41. Thus, a path length from each of the radiation elements 42 to the feed end point 45s of the parallel feed line 45 can be minimized, and a transmission loss in the parallel feed line 45 can be reduced.

(5) The parallel feed line 45 and the radiation element array 40 are formed in a common layer. In other words, the parallel feed line 45 and the radiation element array 40 are acquired by patterning the common conductive layer. Thus, a path length from each of the radiation elements 42, closest to the feed end point 45s of the parallel feed line 45, in the element row 41 to the feed end point 45s of the parallel feed line 45 can be minimized, and a transmission loss in the parallel feed line 45 can be reduced.

(6) The parallel feed line 45 is not provided across a plurality of layers, and is formed in one layer. In other words, the parallel feed line 45 is not provided through a via hole and a through hole. Thus, a transmission loss caused by misalignment between layers does not occur in the parallel feed line 45.

(7) The electronic component 11 is mounted on the planar array antenna 20, and the feed terminal of the electronic component 11 is directly connected to the feed end point 45s of the parallel feed line 45. Thus, transmission loss between the electronic component 11 and the parallel feed line 45 can be reduced.

6. Usage Example of Wireless Module

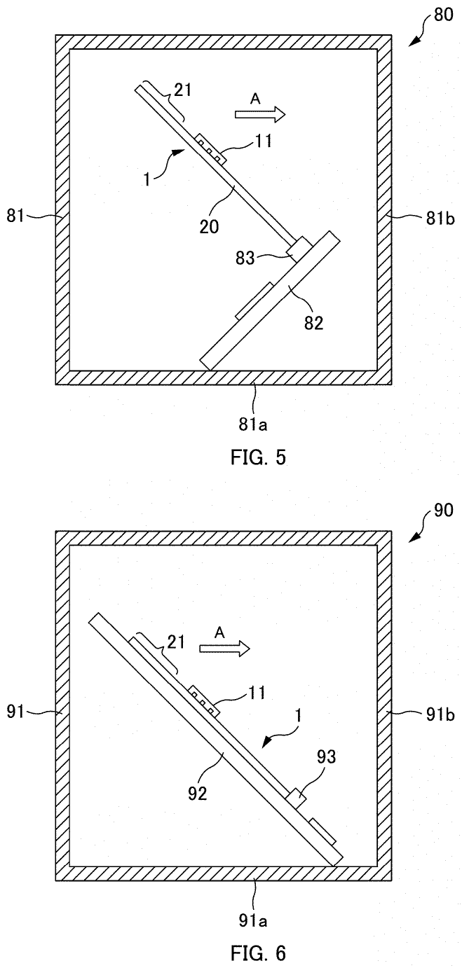

FIG. 5 is a diagram illustrating an internal structure of a wireless device 80 using the wireless module 1. As illustrated in FIG. 5, the wireless device 80 includes the wireless module 1, a housing 81, a printed circuit board 82, and a connector 83. The housing 81 is formed in a box shape, and houses therein the wireless module 1, the printed circuit board 82, and the connector 83. The printed circuit board 82 is fixed in the housing 81 while being inclined with respect to a bottom surface portion 81a of the housing 81. The connector 83 is mounted on the printed circuit board 82. The wireless module 1 is installed on the printed circuit board 82 with the connector 83. Specifically, an end portion on the short side 25 side of the planar array antenna 20 is fit in the connector 83 while the planar array antenna 20 is provided upright with respect to the printed circuit board 82, thereby connecting the end portion 55a of the wiring line 55 to a circuit of the printed circuit board 82 via a terminal of the connector 83. A control unit, a baseband unit, a power supply circuit, an input/output interface, and the like are provided in the circuit of the printed circuit board 82.

The angle of the maximum radiation intensity of the radiation element array 40 is inclined with respect to the normal direction of the planar array antenna 20 as indicated by the arrow A, and thus the printed circuit board 82 is provided in the housing 81 while being inclined with respect to the bottom surface portion 81a of the housing 81. In this way, a direction of the maximum radiation of the radiation element array 40 is directed toward a front surface portion 81b of the housing 81, and is also substantially perpendicular to the front surface portion 81b of the housing 81. Note that the front surface portion 81b of the housing 81 is made of a dielectric material, and a radio wave is not shielded by the front surface portion 81b.

FIG. 6 is a diagram illustrating an internal structure of a wireless device 90 using the wireless module 1. As illustrated in FIG. 6, the wireless device 90 includes the wireless module 1, a housing 91, a printed circuit board 92, and a connector 93. The wireless module 1, the printed circuit board 92, and the connector 93 are housed in the housing 91 having a box shape. The printed circuit board 92 is fixed in the housing 91 while being inclined with respect to a bottom surface portion 91a of the housing 91. The connector 93 is mounted on the printed circuit board 92. The wireless module 1 is installed on the printed circuit board 92 using the connector 93. Specifically, an end portion on the short side 25 side of the planar array antenna 20 is fit in the connector 93 while the planar array antenna 20 is laid down on the printed circuit board 92, thereby connecting the end portion 55a of the wiring line 55 to a circuit of the printed circuit board 92 via a terminal of the connector 93. A control unit, a baseband unit, a power supply circuit, an input/output interface, and the like are provided in the circuit of the printed circuit board 92.

The printed circuit board 92 is provided in the housing 91 while being inclined with respect to a bottom surface portion 91a of the housing 91. In this way, a direction of the maximum radiation of the radiation element array 40 is directed toward a front surface portion 91b of the housing 91, and is also substantially perpendicular to the front surface portion 91b of the housing 91. The front surface portion 91b of the housing 91 is made of a dielectric material, and a radio wave is not shielded by the front surface portion 91b.

7. Modification Examples of Wireless Module

An embodiment of the present disclosure has been described above, but an embodiment described above is for facilitating the understanding of the present disclosure, and is not to be construed as limiting the present disclosure. Further, modifications or improvements may be made to an embodiment described above without departing from the gist of the present disclosure, and the present disclosure encompasses any equivalents thereof. Hereinafter, some modifications of an embodiment described above will be described.

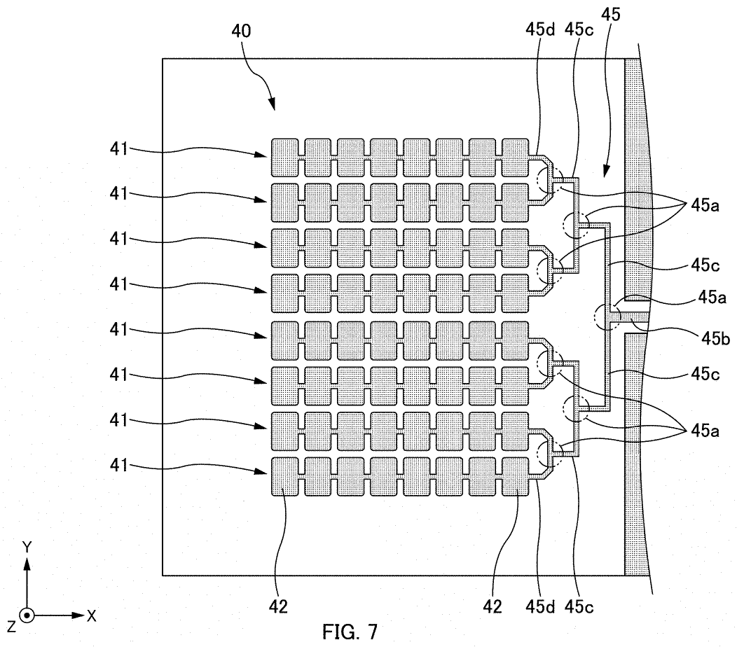

(1) In an embodiment described above, n is two, the number of the element rows 41 is four, and the parallel feed line 45 is a tree-shaped feed line of four distributions including the distribution portions 45a in two stages. In contrast, as illustrated in FIG. 7, n may be three, the number of the element rows 41 may be eight, and the parallel feed line 45 may be a tree-shaped feed line of eight distributions including the distribution portions 45a in three stages. In FIG. 7, the number of the radiation elements 42 included in one row of the element row 41 is eight. A shape of the radiation element 42 illustrated in FIG. 7 is identical to a shape of the radiation element 42 illustrated in FIG. 4. The radiation element array 40 illustrated in FIG. 7 has a larger number of the radiation elements 42 and a larger area than those of the radiation element array 40 illustrated in FIG. 4. Thus, the radiation element array 40 illustrated in FIG. 7 has a gain higher than that of the radiation element array 40 illustrated in FIG. 4.

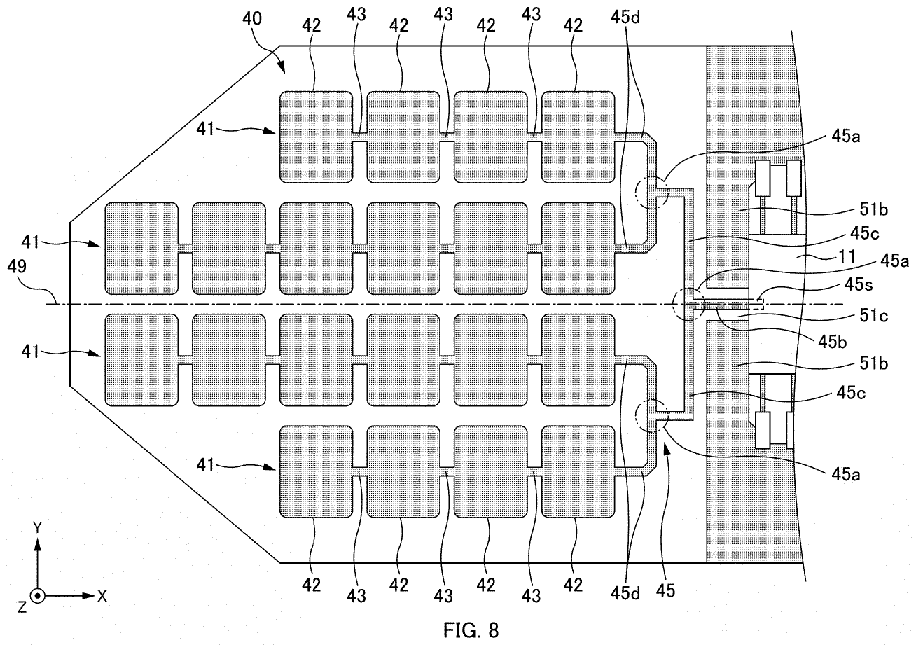

(2) In each example illustrated in FIGS. 4 and 7, all of the element rows 41 are equal in number of the radiation elements 42. Whereas, the element rows 41 may vary in number of the radiation elements 42 according to the shape of the antenna formation region 21 and the like. For example, as illustrated in FIG. 8, the number of the radiation elements 42 in each of the two element rows 41 at the center is six, and the number of the radiation elements 42 in each of the two element rows 41 on both sides is four, such that the number of the radiation elements 42 in a row gradually decreases from the center row toward the side row. Note that, in the example illustrated in FIG. 8, the number of the radiation elements 42 in a row gradually decreases from the center rows toward the side rows by two due to the shape of the antenna formation region 21, but may gradually decrease by one when the shape of the antenna formation region 21 is different. The number of the radiation elements 42 is preferably increased as much as possible in order to increase a gain of an antenna. Further, although not illustrated, the number of the radiation elements 42 in a row may gradually increase from the center rows toward the side rows.

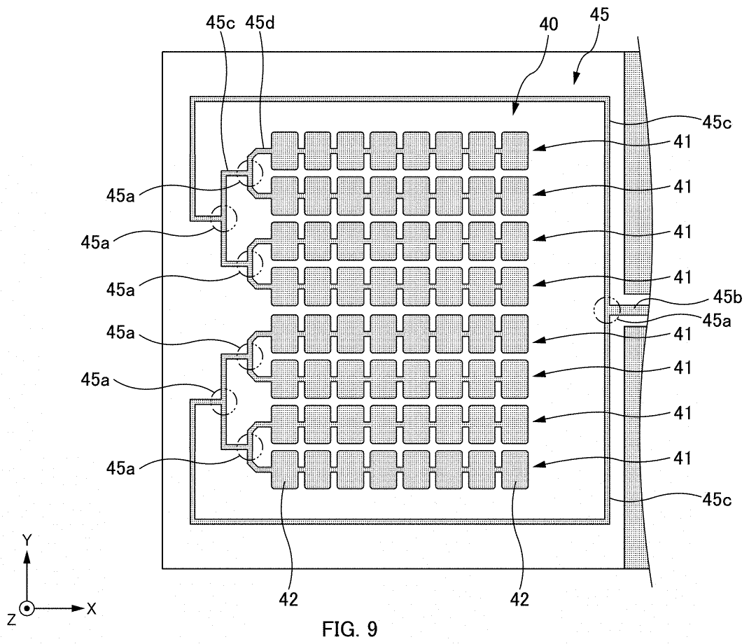

(3) The parallel feed line 45 illustrated in FIGS. 4 and 7 supplies electric power to the radiation elements 42, closest to the feed end point 45s of the parallel feed line 45, in the element rows 41. In contrast, the parallel feed line 45 illustrated in FIG. 9 supplies electric power to the radiation elements 42, farthest from the feed end point 45s of the parallel feed line 45 in the element rows 41. Here, the distribution portion 45a in the first stage of the parallel feed line 45 illustrated in FIG. 9 is disposed in a region between the radiation element array 40 and the electronic component 11. The distribution portions 45a in the second and subsequent stages are disposed in a region on the side opposite to the electronic component 11 with respect to the radiation element array 40. The feed line 45c that connects the distribution portion 45a in the first stage to the distribution portion 45a in the second stage is routed from the electronic component 11 to the side opposite to the electronic component 11 through both side portions of the radiation element array 40. In a case of FIG. 9, the angle of the maximum radiation intensity of the radiation element array 40 is inclined toward the side opposite to the electronic components 11 to 17 with respect to the normal direction of the planar array antenna 20.

### Second Embodiment

1. Overview of Wireless Module

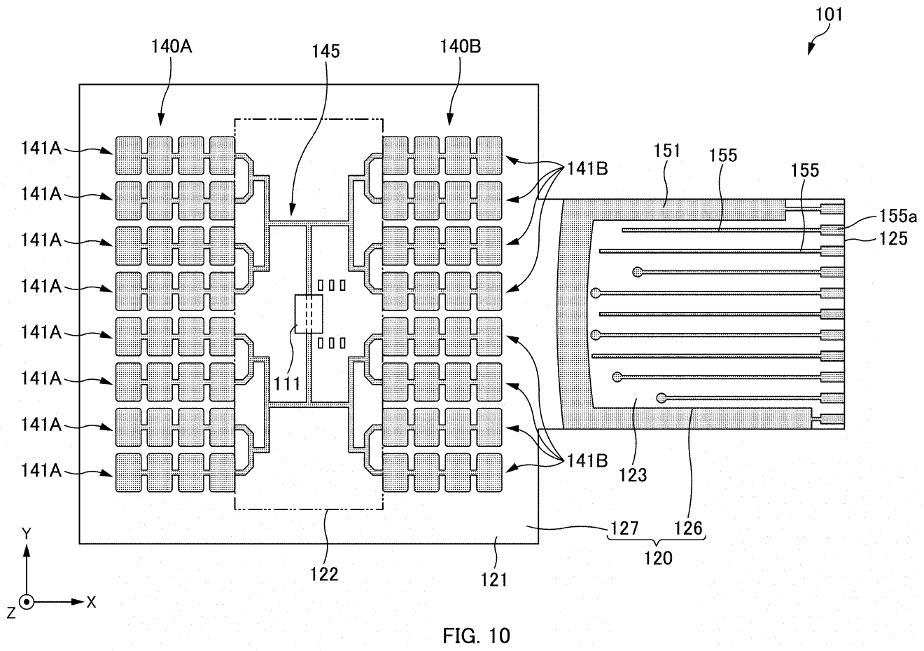

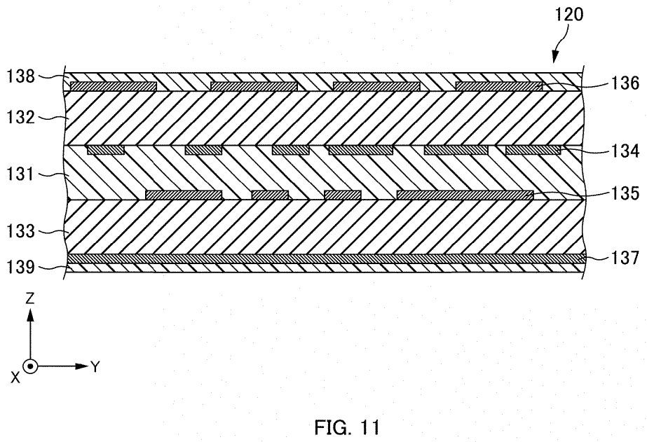

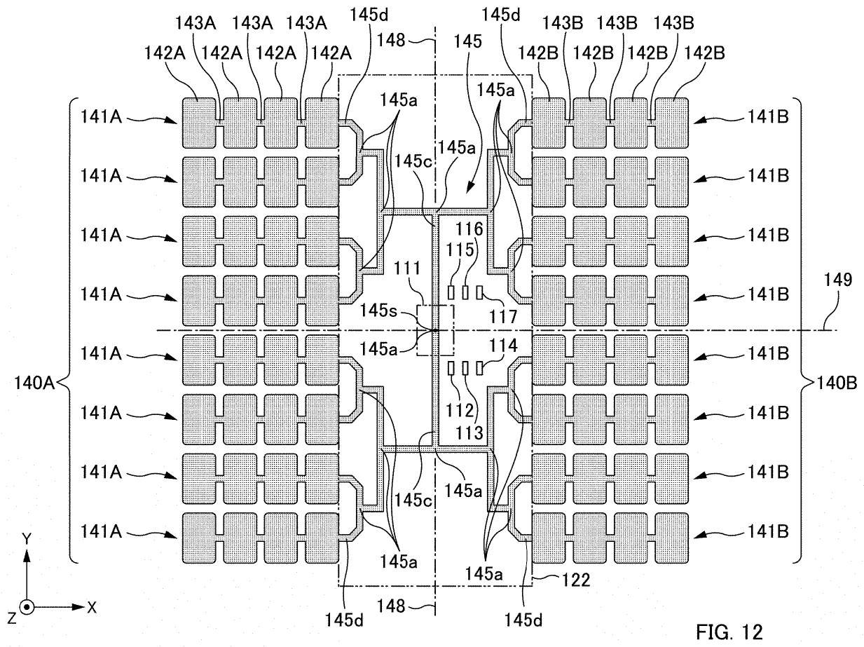

FIG. 10 is a plan view of a wireless module 101. FIG. 11 is a cross-sectional view of a planar array antenna 120 of the wireless module 101. FIG. 12 is an enlarged plan view of a main part of the wireless module 101. In the drawing, an X axis, a Y axis, and a Z axis are illustrated as auxiliary lines representing directions. The X axis, the Y axis, and the Z axis are orthogonal to each other.

The wireless module 101 is a module that transmits, receives, or transmits and receives a radio wave in a frequency band of a microwave or a millimeter wave. The wireless module 101 includes the planar array antenna 120, and electronic components 111 to 117 that are surface-mounted on the planar array antenna 120. Here, the X axis and the Y axis are parallel to a front surface and a back surface of the planar array antenna 120.

2. Planar Array Antenna

As illustrated in FIG. 10, the planar array antenna 120 is formed in a shape in which rectangular planar portions 126 and 127 are integrated with each other by connecting a short side of a rectangular planar portion 126 to a central portion of one side of a rectangular planar portion 127. As illustrated in FIG. 11, the planar array antenna 120 includes a dielectric adhesive layer 131, dielectric base materials 132 and 133, conductive pattern layers 134, 135, and 136, a conductive ground layer 137, and passivation films 138 and 139, similarly to the planar array antenna 20 in the first embodiment. The dielectric adhesive layer 131, the dielectric base materials 132 and 133, the conductive pattern layers 134, 135, and 136, the conductive ground layer 137, and the passivation films 138 and 139 in the second embodiment respectively correspond to the dielectric adhesive layer 31, the dielectric base materials 32 and 33, the conductive pattern layers 34, 35, and 36, the conductive ground layer 37, and the passivation films 38 and 39 in the first embodiment.

Here, the planar array antenna 120 is divided into three rectangular regions 121 to 123 as illustrated in FIG. 10. The region 121 is a rectangular frame-shaped region of a peripheral portion of the rectangular planar portion 127. The region 122 is a rectangular region of a central portion of the rectangular planar portion 127 surrounded by the region 121. The region 123 is a rectangular region corresponding to the rectangular planar portion 126. Hereinafter, the region 121 may also be referred to as an antenna formation region 121, the region 122 may also be referred to as a feed line formation region 122, and the region 123 may also be referred to as a signal line formation region 123.

3. Electronic Component

As illustrated in FIGS. 10 and 12, the electronic components 111 to 117 are surface-mounted on the planar array antenna 120, in other words, on a surface of the dielectric base material 132 on the side opposite to the dielectric adhesive layer 131. The electronic components 111 to 117 are mounted in a central portion of the feed line formation region 122.

The electronic components 111 to 117 in the second embodiment correspond to the electronic components 11 to 17 in the first embodiment.

4. Conductive Pattern Layer of Planar Array Antenna

The conductive pattern layer 136 is patterned (shape-processed), and thus the conductive pattern layer 136 will be described with reference to FIGS. 10 and 12. In FIGS. 10 and 12, the conductive pattern layer 136 is drawn with a dotted pattern, and also the passivation film 138 is omitted, in order to make the conductive pattern layer 136 easier to see.

By patterning the conductive pattern layer 136, the conductive pattern layer 136 is provided with 2ⁿ rows (n is an integer of one or more) of element rows 141A and 141B, a parallel feed line 145 of 2ⁿ distributions, a conductive ground portion 151, and a large number of wiring lines 155. Note that, in the examples illustrated in FIGS. 10 and 12, n is four, the total number of the element rows 141A and 141B is 16, the number of the element rows 141A is eight, and the number of the element rows 141B is eight.

The conductive ground portion 151 is formed in a U shape along long sides on both sides of the signal line formation region 123 and a short side, of the rectangular planar portion 126, on the rectangular planar portion 127 side. The conductive ground portion 151 is connected to the terminals of the electronic components 111 to 117 via a via hole, the conductive pattern layers 134 and 135, and the like, and a reference potential (ground potential) is applied to the terminals of the electronic components 111 to 117 from the conductive ground portion 151. Further, the conductive ground portion 151 is connected to the conductive ground layer 137 (see FIG. 11) through a via hole, and the reference potential is applied to the conductive ground layer 137 from the conductive ground portion 151.

The wiring lines 155 are formed in the signal line formation region 123 so as to be routed in a long-side direction (X direction) of the rectangular planar portion 126 from a short side 125 of the rectangular planar portion 126 of the planar array antenna 120 toward the rectangular planar portion 127. End portions 155a of the wiring lines 155 are formed in an island shape so as to have a width greater than that of the other portion, and are aligned along the short side 25 of the rectangular planar portion 126. The end portions 155a of the wiring lines 155 are connecting terminals. The end portions 155a of the wiring lines 155 are exposed without being covered with the passivation film 138.

Some of the wiring lines 155 are routed from the short side 125 of the rectangular planar portion 126 of the planar array antenna 120 to the conductive ground portion 151, and are connected to the conductive ground portion 151. Others of the wiring lines 155 are routed from the short side 125 of the rectangular planar portion 126 of the planar array antenna 120 to a short side on an opposite side, and is connected to the terminal of the electronic components 111 to 117 via a via hole, the conductive pattern layers 134 and 135, and the like. The wiring lines 155 connected to the terminal of the electronic components 111 to 117 include a power supply line that supplies a power supply voltage to the electronic component 111, a clock line that supplies an operation clock to the electronic component 111, a signal line that supplies various signals to the electronic components 111 to 117, and the like.

As illustrated in FIG. 12, 2ⁿ rows of the element rows are formed in the antenna formation region 121. Specifically, 2ⁿ⁻¹ rows of the element rows 141A and 2ⁿ⁻¹ rows of the element rows 141B are disposed in the antenna formation region 121 with the feed line formation region 122 disposed therebetween. The element rows 141B are disposed closer to the rectangular planar portion 126 than the feed line formation region 122 is. The element rows 141A are disposed on a side opposite to the element rows 141B with respect to the feed line formation region 122.

Each of the element rows 141A includes a plurality of patch-type radiation elements 142A and direct-coupled feed lines 143A. In each of the element rows 141A, the plurality of radiation elements 142A are aligned linearly at regular intervals in the long-side direction (X direction) of the rectangular planar portion 126 of the planar array antenna 120. All of the element rows 141A have an identical pitch (pitch indicates an interval between the radiation elements 142A adjacent to each other in the X direction). These radiation elements 142A are connected in series using the direct-coupled feed lines 143A provided between the radiation elements 142A adjacent to each other. In the example illustrated in FIG. 12, the number of the radiation elements 142A included in one row of the element rows 141A is four, but the number thereof may be two to three, or may be five or more.

Further, in the example illustrated in FIG. 12, all of the element rows 141A are equal in number of the radiation elements 142A. However, the element rows 141A may vary in number of the radiation elements 142.

The above-described 2ⁿ⁻¹ rows of the element rows 141A are arranged in parallel at regular intervals in a short-side direction (Y direction) of the rectangular planar portion 126 of the planar array antenna 120, and thus the radiation elements 142A are arranged in a grid pattern as the entire 2ⁿ⁻¹ rows of the element rows 141A.

The radiation elements 142A, at ends of the element rows 141A closest to a feed end point 145s (feed terminal of the electronic component 111) of the parallel feed line 145, in the respective element rows 141A are aligned in terms of their position in the X direction. In other words, the radiation elements 142A at the ends closest to the feed end point 145s (feed terminal of the electronic component 111) of the parallel feed line 145 in the respective element rows 141A are arranged in a line in a direction (Y direction) perpendicular to a direction (X direction) of the element row 141A.

All the intervals between the element rows 141A adjacent to each other (intervals between the radiation elements 142A adjacent to each other in the Y direction) are identical. An interval between the radiation elements 142A adjacent to each other in the Y direction and an interval between the radiation elements 142A adjacent to each other in the X direction may be identical or may be different. Hereinafter, the element rows 141A being arranged in parallel is referred to as a radiation element array 140A.

The radiation element array 140A is formed to be line-symmetric with respect to a symmetrical line 149. The symmetrical line 149 is parallel to the direction (X direction) of the element row 141A and passes through the feed endpoint 145s (feed terminal of the electronic component 111) of the parallel feed line 145 described later. Since the number of the element rows 141A is an even number, none of the element rows 141A is disposed on the symmetrical line 149.

Note that, even in a case where the number of the radiation elements 142 in each of the plurality of element rows 141A is not equal in the radiation element array 140A, the radiation element array 140A is formed to be line-symmetric with respect to the symmetrical line 149.

Similarly to the element rows 141A, each of the element rows 141B includes a plurality of patch-type radiation elements 142B aligned linearly at regular intervals in the long-side direction (X direction) of the rectangular planar portion 126 of the planar array antenna 120, and direct-coupled feed lines 143B that connect the radiation elements 142B in series. All of the element rows 141B have an identical pitch (interval between the radiation elements 142B adjacent to each other in the X direction).

An alignment direction of the radiation elements 142B in each of the element rows 141B and an alignment direction of the radiation elements 142A in each of the element rows 141A are parallel to each other. A pitch of the radiation elements 142B (interval between the radiation elements 142B adjacent to each other in the X direction) in each of the element rows 141B is identical to a pitch of the radiation elements 142A (interval between the radiation elements 142A adjacent to each other in the X direction) in each of the element rows 141A. Further, the number of the radiation elements 142B included in one row of the element rows 141B and the number of the radiation elements 142A included in one row of the element rows 141A are equal to each other.

The above-described 2ⁿ⁻¹ rows of the element rows 141B are arranged in parallel at regular intervals in the short-side direction (Y direction) of the rectangular planar portion 126 of the planar array antenna 120, and thus the radiation elements 142B are aligned in a grid pattern as the entire 2ⁿ⁻¹ rows of the element rows 141B.

The radiation elements 142B, at ends of the element rows 141B closest to the feed end point 145s (feed terminal of the electronic component 111) of the parallel feed line 145, in the respective element rows 141B are aligned in terms of their position in the X direction. In other words, the radiation elements 142B at the ends closest to the feed end point 145s of the parallel feed line 145 in the respective element rows 141B are arranged in a line in a direction (Y direction) perpendicular to the direction (X direction) of the element rows 141B.

An interval between the element rows 141B adjacent to each other (interval between the radiation elements 142B adjacent to each other in the Y direction) is identical to an interval between the element rows 141A adjacent to each other (interval between the radiation elements 142A adjacent to each other in the Y direction). Hereinafter, the element rows 141B being arranged in parallel is referred to as a radiation element array 140B.

The radiation element array 140B and the radiation element array 140A are aligned in the direction (X direction) of the element rows 141A and 141B, and the feed line formation region 122 is disposed between the radiation element array 140B and the radiation element array 140A.

A composite shape of the radiation element array 140A and the radiation element array 140B is line-symmetric with respect to a symmetrical line 148 orthogonal to the symmetrical line 149 at the feed end point 145s of the parallel feed line 145. Further, the composite shape of the radiation element array 140A and the radiation element array 140B has two-fold rotational symmetry around the feed end point 145s of the parallel feed line 145.

In order to allow the radiation element arrays 140A and 140B to function as a microstrip antenna, the conductive ground layer 137 (see FIG. 3) is formed so as to spread in the entire antenna formation region 121, and the dielectric adhesive layer 131 and the dielectric base materials 132 and 133 are interposed between the conductive ground layer 137 and the radiation elements 142A and 142B.

The parallel feed line 145 is formed in the feed line formation region 122. The parallel feed line 145 connects between 2ⁿ⁻¹ rows of the element rows 141A and 141B and the feed terminal of the electronic component 111. A connecting section of the parallel feed line 145 and the feed terminal of the electronic component 111 corresponds to the feed end point 145s of the parallel feed line 145.

When a transmission circuit is incorporated in the electronic component 111, the electronic component 111 supplies high-frequency electric power to the parallel feed line 145 through the feed terminal and the feed end point 145s. Then, the parallel feed line 145 divides and transmits, to 2ⁿ⁻¹ rows of the element rows 141A and 141B, the high-frequency electric power supplied to the feed end point 145s by the electronic component 111.

The parallel feed line 145 includes n stages of T-type distribution portions 145a, and is formed in a shape of a tree branching into 2ⁿ from the feed terminal of the electronic component 111 to the element rows 141A and 141B using the distribution portion 145a. Note that, in a case of reception of a radio wave, the distribution portion 145a is a synthesizing portion.

The number of the distribution portions 145a in an m-th stage (m is a given integer from one to n) from the feed terminal of the electronic component 111 is 2^{m-1}.

The feed end point 145s of the parallel feed line 145 is the distribution portion 145a in the first stage from the electronic component 111, and the feed terminal of the electronic component 111 is connected to the feed end point 145s of the parallel feed line 145.

The distribution portions 145a in adjacent stages are connected using a feed line 145c.

The distribution portions 145a in an n-th stage from the electronic component 111 are connected, via a feed line 145d, to the element rows 141A (particularly, the radiation elements 142A at the ends closest to the feed end point 145s of the parallel feed line 145) or to the element rows 141B (particularly, the radiation elements 142B at the ends closest to the feed end point 145s of the parallel feed line 145).

In a case of transmission, each of the distribution portions 145a divides high-frequency electric power transmitted from the electronic component 111 or the distribution portion 145a in a previous stage into two, and transmits the high-frequency electric power to the distribution portions 145a in a subsequent stage, the element rows 141A (particularly, the radiation elements 142A at the ends closest to the feed end point 145s of the parallel feed line 145), or the element rows 141B (particularly, the radiation elements 142B at the ends closest to the feed end point 145s of the parallel feed line 145). In a case of reception, each of the distribution portions 45a synthesizes high-frequency electric power transmitted from the distribution portions 145a in a subsequent stage, the element rows 141A (particularly, the radiation elements 142A at the ends closest to the feed end point 145s of the parallel feed line 145), or the element rows 141B (particularly, the radiation elements 142B at the ends closest to the feed end point 145s of the parallel feed line 145), and transmits the high-frequency electric power to the electronic component 111 or the distribution portion 145a in a previous stage.

Further, all of the element rows 141A and 141B have an identical path length (electrical length) from each of the radiation elements 142A and 142B at the ends closest to the feed end point 145s of the parallel feed line 145 to the feed end point 145s of the parallel feed line 145 through the parallel feed line 145. Therefore, electric power in the same phase is supplied to all of the radiation elements 142A and 142B at the ends closest to the feed end point 145s of the parallel feed line 145.

Further, since the radiation element array 140A is formed to be line-symmetric with respect to the symmetrical line 149, electric power in the same phase is supplied to the radiation elements 142A that are disposed at positions symmetric to each other with respect to the symmetrical line 149. The same applies to the radiation element array 140B.

The radiation elements 142A included in the same element row 141A have a phase of electric supply that is delayed as the radiation element 142A becomes distant from the parallel feed line 145. Thus, the radiation element array 140A has radio wave directivity having the maximum radiation intensity in a direction inclined toward the electronic component 111 with respect to a normal direction of the planar array antenna 120. The same applies to the radiation element array 140B.

Further, since the radiation element array 140A and the radiation element array 140B are line-symmetric with respect to the symmetrical line 148, the radiation element array 140A and the radiation element array 140B are substantially equal in radiation intensity and are also substantially equal in angle of inclination toward the electronic component 111.

Therefore, a composite antenna of the radiation element array 140A and the radiation element array 140B has radio wave directivity having the maximum radiation intensity in a direction of a normal line of the planar array antenna 120 by synthesizing the radio wave directivity of the radiation element array 140A and the radio wave directivity of the radiation element array 140B.

Note that, in order to allow the parallel feed line 145 to function as a microstrip-line-type signal transmission path, the conductive ground layer 137 (see FIG. 11) is formed so as to spread in the entire feed line formation region 122, and the dielectric adhesive layer 131 and the dielectric base materials 132 and 133 are interposed between the conductive ground layer 137 and the parallel feed line 145.

5. Effects

The wireless module 1 configured as described above has the following effects and advantages.

(1) Since the radiation element arrays 140A and 140B include the plurality of radiation elements 142A and 142B arranged in a grid pattern, the number of the radiation elements 142A and 142B is large, and the area of the radiation element arrays 140A and 140B is large. Thus, it is possible to achieve a high gain of the composite antenna of the radiation element arrays 140A and 140B, and long distance transmission of a radio wave.

(2) A direction of the maximum radiation intensity of the composite antenna of the radiation element array 140A and the radiation element array 140B results in a normal direction of the planar array antenna 120 by synthesizing the radio wave directivity of the radiation element array 140A and the radio wave directivity of the radiation element array 140B.

(3) All of the distribution portions 145a of the parallel feed line 145 are disposed in the region between the radiation element array 140A and the radiation element array 140B. Thus, a path length from each of the radiation elements 142A and 142B to the feed end point 145s can be minimized, and a transmission loss in the parallel feed line 145 can be reduced.

(4) The parallel feed line 145 is connected to the radiation elements 142A and 142B, closest to the feed end point 145s of the parallel feed line 145, in the element rows 141A and 141B. Thus, a path length from each of the radiation elements 142A and 142B to the feed end point 145s of the parallel feed line 145 can be minimized, and a transmission loss in the parallel feed line 145 can be reduced.

(5) Since the parallel feed line 145 and the radiation element arrays 140A and 140B are formed in a common layer, a path length from each of the radiation elements 142A and 142B, closest to the feed end point 145s of the parallel feed line 145, in the element rows 141A and 141B to the feed end point 145s of the parallel feed line 145 can be minimized. Thus, a transmission loss in the parallel feed line 145 can be reduced.

(6) Since the parallel feed line 145 is formed in one layer, a transmission loss caused by misalignment between layers does not occur.

(7) Since the feed terminal of the electronic component 111 is directly connected to the feed end point 145s of the parallel feed line 145, a transmission loss between the electronic component 111 and the parallel feed line 145 can be reduced.

6. Modification Examples of Wireless Module

An embodiment of the present disclosure has been described above, but an embodiment described above is for facilitating the understanding of the present disclosure, and is not to be construed as limiting the present disclosure. Further, modifications or improvements may be made to an embodiment described above without departing from the gist of the present disclosure, and the present disclosure encompasses any equivalents thereof. Hereinafter, some modifications of an embodiment described above will be described.

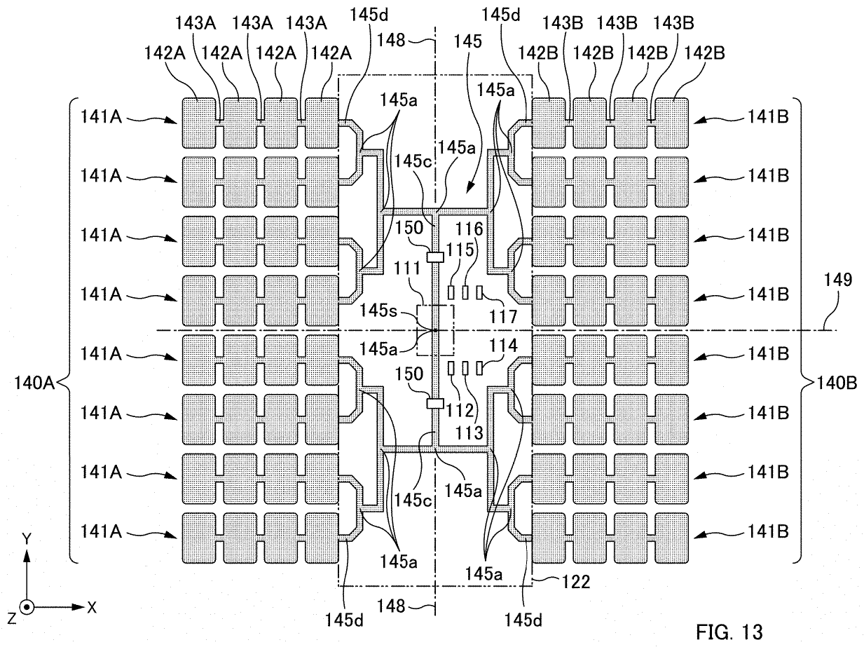

(1) As illustrated in FIG. 13, a plurality of amplifiers 150 are surface-mounted on the planar array antenna 120, in other words, on the surface of the dielectric base material 132 on the side opposite to the dielectric adhesive layer 131. The amplifiers 150 each are provided at a halfway portion of the feed line 145c that connects the distribution portion 145a in the first stage to each of the distribution portions 145a in the second stage, and a signal passing through the feed line 145c is amplified by the amplifier 150. The feed line 145c is divided into a portion closer to the distribution portion 145a in the first stage with respect to the amplifier 150 and a portion closer to the distribution portion 145a in the second stage with respect to the amplifier 150. Then, both of the divided portions are connected via the amplifier 150.

The amplifiers 150 are disposed at positions that are point-symmetric with respect to the feed end point 145s of the parallel feed line 145. Further, the amplifiers 150 are disposed at positions that are line-symmetric with respect to the symmetrical line 149. All of the amplifiers 150 have an identical path length (electrical length) from the amplifier 150 to the feed end point 145s of the parallel feed line 145.

The amplifiers 150 are connected to the wiring line(s) 155 via a via hole(s), the conductive pattern layers 134 and 135, and the like, and a power supply voltage is supplied from the wiring line(s) 155 to the amplifier 150. The amplifiers 150 each are, for example, a preamplifier (in a case where the electronic component 111 is a transmission circuit) or a low noise amplifier (in a case where the electronic component 111 is a reception circuit).

When signals are amplified by the amplifiers 150, long distance transmission of radio waves can be achieved.

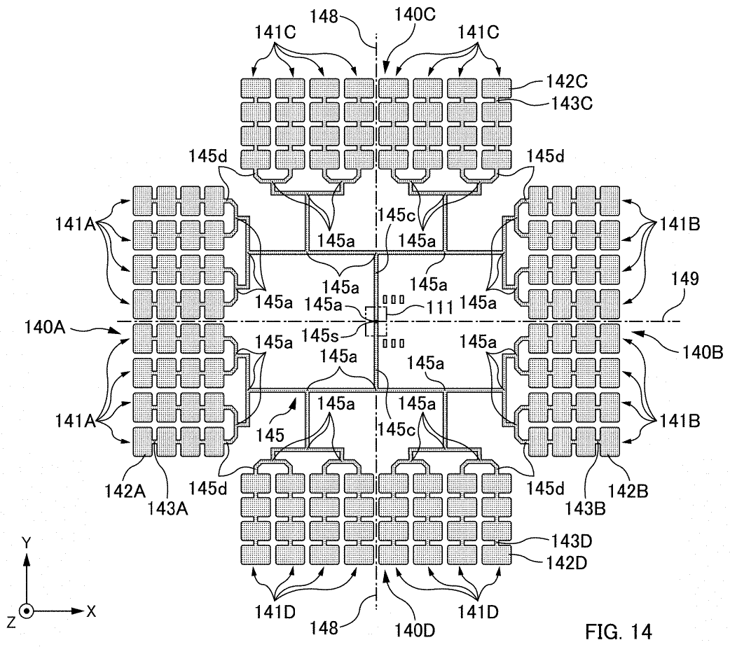

(2) In an embodiment described above, the radiation element array 140A and the radiation element array 140B are aligned in the X direction, and the feed line formation region 122 is disposed between the radiation element array 140A and the radiation element array 140B. As illustrated in FIG. 14, in addition to the radiation element arrays 140A and 140B, a radiation element array 140C and a radiation element array 140D may be aligned in the Y direction, and the feed line formation region 122 may be disposed between the radiation element array 140C and the radiation element array 140D. Here, the radiation element array 140C includes a plurality of element rows 141C, and the radiation element array 140D includes a plurality of element rows 141D.

In this case, assuming that the total number of the element rows 141A, 141B, 141C, and 141D is 2ⁿ (however, n is an integer of two or more), the number of the element rows 141A is 2ⁿ⁻², the number of the element rows 141B is 2ⁿ⁻², the number of the element rows 141C is 2ⁿ⁻², and the number of the element rows 141D is 2ⁿ⁻². In the example illustrated in FIG. 14, n is five, each of the element rows 141A, 141B, 141C, and 141D is eight, and the total number of the element rows 141A, 141B, 141C, and 141D is 32.

Each of the element rows 141C includes a plurality of patch-type radiation elements 142C and direct-coupled feed lines 143C. In any of the element rows 141C, the plurality of radiation elements 142C are aligned linearly at regular intervals in the short-side direction (Y direction) of the rectangular planar portion 126 of the planar array antenna 120. These radiation elements 142C are connected in series using the direct-coupled feed lines 143C provided between the radiation elements 142C adjacent to each other. All of the element rows 141C have an identical pitch (pitch indicates an interval between the radiation elements 142C adjacent to each other in the Y direction).

Similarly to the element row 141C, the element row 141D includes a plurality of patch-type radiation elements 142D aligned linearly at regular intervals in the short-side direction (Y direction) of the rectangular planar portion 126 of the planar array antenna 120, and direct-coupled feed lines 143D that connect the radiation elements 142D in series. All of the element rows 141D have an identical pitch (pitch indicates an interval between the radiation elements 142D adjacent to each other in the Y direction).

The element rows 141C of 2ⁿ⁻² rows are arranged in parallel at regular intervals in the long-side direction (X direction) of the rectangular planar portion 126 of the planar array antenna 120. The element rows 141D of 2ⁿ⁻² rows are arranged in parallel at regular intervals in the long-side direction (X direction) of the rectangular planar portion 126 of the planar array antenna 120.

The radiation elements 142C, at the ends closest to the feed end point 145s (feed terminal of the electronic component 111) of the parallel feed line 145, in the respective element rows 141C are aligned in terms of their position in the Y direction. In other words, the radiation elements 142C, at the ends closest to the feed end point 145s (feed terminal of the electronic component 111) of the parallel feed line 145, in the respective element rows 141C are arranged in a line in a direction (X direction) perpendicular to the direction (Y direction) of the element row 141C. The same applies to the radiation element array 140D.

An alignment direction of the radiation elements 142C in the element row 141C and an alignment direction of the radiation elements 142D in the element row 141D are parallel to each other. An alignment direction of the radiation elements 142C and 142D in the element rows 141C and 141D and an alignment direction of the radiation elements 142A and 142B in the element rows 141A and 141B are perpendicular to each other.

Furthermore, all of the element rows 141A, 141B, 141C, and 141D have an identical pitch. Further, all of a parallel row interval between the element rows 141A, a parallel row interval between the element rows 141B, a parallel row interval between the element rows 141C, and a parallel row interval between the element rows 141D are identical.

A composite shape of the radiation element arrays 140A, 140B, 140C, and 140D is line-symmetric with respect to the symmetrical lines 148 and 149. Further, the composite shape of the radiation element arrays 140A, 140B, 140C, and 140D has four-fold rotational symmetry around the feed end point 145s of the parallel feed line 145.

The parallel feed line 145 is formed in a shape of a tree branching into 2ⁿ from the feed terminal of the electronic component 111 to the element rows 141A, 141B, 141C, and 141D using n stages of the distribution portions 145a. Therefore, the distribution portion 145a in an n-th stage from the electronic component 111 is connected to the element rows 141A (particularly, the radiation elements 142A at the ends closest to the feed end point 145s of the parallel feed line 145) via the feed line 145d, to the element rows 141B (particularly, the radiation elements 142B at the ends closest to the feed end point 145s of the parallel feed line 145), to the element rows 141C (particularly, the radiation elements 142C at the ends closest to the feed end point of the parallel feed line 145), or to the element rows 141D (particularly, the radiation elements 142D at the ends closest to the feed end point 145s of the parallel feed line 145).

A composite antenna of the radiation element arrays 140A to 140D has radio wave directivity having the maximum radiation intensity in a direction of the normal line of the planar array antenna 120 by synthesizing the radio wave directivity of the radiation element arrays 140A to 140D. Thus, the composite antenna of the radiation element arrays 140A to 140D illustrated in FIG. 14 has a gain higher than that of the composite antenna of the radiation element arrays 140A and 140B illustrated in FIG. 12.

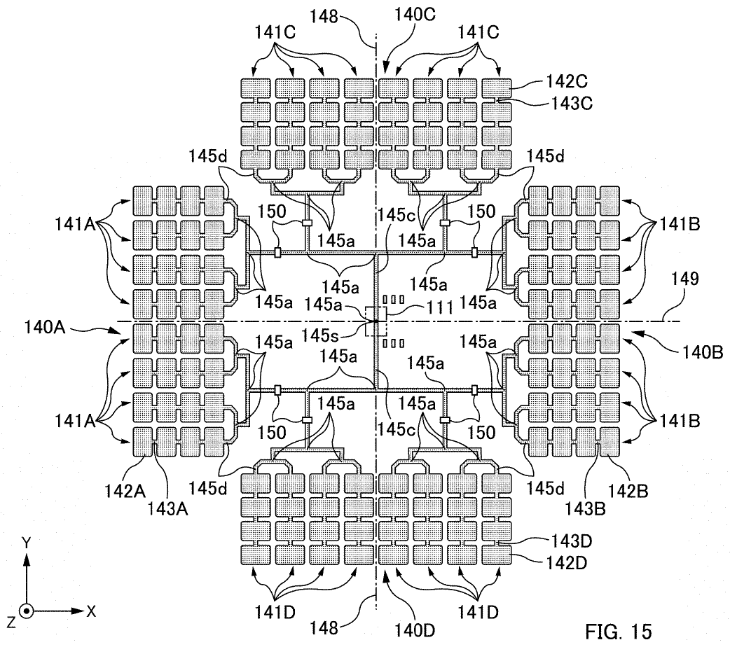

Note that, similarly to the modification example (1) described above, the plurality of amplifiers 150 may be surface-mounted on the planar array antenna 120 (see FIG. 15). The amplifiers 150 each are provided at a halfway portion of the feed line 145c that connects the distribution portion 145a in the third stage to the distribution portion 145a in the fourth stage (see FIG. 15), and a signal passing through the feed line 145c is amplified by the amplifier 150.

These amplifiers 150 are disposed at positions that are point-symmetric with respect to the feed end point 145s of the parallel feed line 145. Further, the amplifiers 150 are disposed at positions that are line-symmetric with respect to the symmetrical line 149. Further, the amplifiers 150 are disposed at positions that are line-symmetric with respect to the symmetrical line 148. All of the amplifiers 150 have an identical path length (electrical length) from the amplifier 150 to the feed end point 145s of the parallel feed line 145.

### REFERENCE SIGNS LIST

1, 101: Wireless module;
20, 120: Planar array antenna;
21, 121: Antenna formation region;
22, 122: Feed line formation region;
31, 131: Dielectric adhesive layer;
32, 132, 33, 133: Dielectric base material;
37, 137: Conductive ground layer;
41, 141A, 141B, 141C, 141D: Serial-type radiation element row;
42, 142A, 142B, 142C, 142D: Radiation element;
45, 145: Parallel feed line;
45s, 145s: Feed end point;
150: Amplifier.

1. A planar array antenna comprising:
a dielectric substrate;
a conductive ground layer formed on one surface of the dielectric substrate;
a plurality of serial-type radiation element rows formed on another surface of the dielectric substrate; and
a parallel feed line that is formed on the other surface of the dielectric substrate and supplies high-frequency electric power between a feed end point on the other surface of the dielectric substrate and the plurality of serial-type radiation element rows,
the serial-type radiation element rows each including a plurality of radiation elements, the plurality or radiation elements being aligned linearly at regular intervals and connected in series,
the parallel feed line branching into the number of the serial-type radiation element rows from the feed end point to the radiation elements, at ends of the serial-type radiation element rows closest to the feed end point, in the plurality of radiation elements in the serial-type radiation element rows, and connecting the feed end point to the radiation elements at the ends closest to the feed end point,
all of the plurality of serial-type radiation element rows having an identical pitch between the plurality of radiation elements, and
all of the plurality of serial-type radiation element rows having an identical path length, along the parallel feed line, from the feed end point to each of the radiation elements at the ends closest to the feed end point.

2. The planar array antenna according to claim 1, wherein
the plurality of serial-type radiation element rows are arranged in parallel, and
the radiation elements at the ends closest thereto in the plurality of serial-type radiation element rows are arranged in a line in a direction perpendicular to a direction of the serial-type radiation element rows.

3. The planar array antenna according to claim 2, wherein
the parallel feed line is disposed within a region between the feed end point and the radiation elements at the ends closest thereto in the plurality of serial-type radiation element rows.

4. The planar array antenna according to claim 2, wherein
an entire shape of the plurality of serial-type radiation element rows is line-symmetric with respect to a symmetrical line, the symmetrical line being parallel to the direction of the serial-type radiation element rows and passing through the feed end point.

5. The planar array antenna according to claim 1, wherein
when the plurality of serial-type radiation element rows are divided into two groups,
the plurality of serial-type radiation element rows included in the first group are arranged in parallel, and the radiation elements at the ends closest thereto in the plurality of serial-type radiation element rows in the first group are arranged in a line in a direction perpendicular to a direction of the serial-type radiation element row in the first group,
the plurality of serial-type radiation element rows included in the second group are arranged in parallel so as to be parallel to the direction of the serial-type radiation element rows in the first group, and the radiation elements at the ends closest thereto in the plurality of serial-type radiation element rows in the second group are arranged in a line in a direction perpendicular to a direction of the serial-type radiation element rows in the second group, and
the plurality of serial-type radiation element rows in the first group and the plurality of serial-type radiation element rows in the second group are arranged in the direction of their rows.

6. The planar array antenna according to claim 5, wherein
the feed end point is disposed within a region between the plurality of serial-type radiation element rows in the first group and the plurality of serial-type radiation element rows in the second group.

7. The planar array antenna according to claim 6, wherein
the parallel feed line is disposed within the region.

8. The planar array antenna according to claim 5, wherein
an entire shape of the plurality of serial-type radiation element rows is line-symmetric with respect to a symmetrical line, the symmetrical line being perpendicular to a direction of the serial-type radiation element rows and passing through the feed end point.

9. The planar array antenna according to claim 5, wherein
an entire shape of the plurality of serial-type radiation element rows is line-symmetric with respect to a symmetrical line, the symmetrical line being parallel to the direction of the serial-type radiation element rows and passing through the feed end point.

10. The planar array antenna according to claim 5, wherein
an entire shape of the plurality of serial-type radiation element rows has two-fold rotational symmetry around the feed end point.

11. The planar array antenna according to claim 1, wherein
when the plurality of serial-type radiation element rows are divided into four groups,
the plurality of serial-type radiation element rows included in a first group are arranged in parallel, and the radiation elements at the ends closest thereto in the plurality of serial-type radiation element rows in the first group are aligned in a direction perpendicular to a direction of the serial-type radiation element rows in the first group,
the plurality of serial-type radiation element rows included in a second group are arranged in parallel so as to be parallel to the direction of the serial-type radiation element rows in the first group, and the radiation elements at the ends closest thereto in the plurality of serial-type radiation element rows in the second group are aligned in a direction perpendicular to a direction of the serial-type radiation element rows in the second group,
the plurality of serial-type radiation element rows in the first group and the plurality of serial-type radiation element rows in the second group are arranged in the direction of their rows,
the plurality of serial-type radiation element rows included in a third group are arranged in parallel so as to be perpendicular to the direction of the serial-type radiation element rows in the first group, and the radiation elements at the ends closest thereto in the plurality of serial-type radiation element rows in the third group are aligned in a direction perpendicular to a direction of the serial-type radiation element rows in the third group,
the plurality of serial-type radiation element rows included in a fourth group are arranged in parallel so as to be parallel to the direction of the serial-type radiation element rows in the third group, and the radiation elements at the ends closest thereto in the plurality of serial-type radiation element rows in the fourth group are aligned in a direction perpendicular to a direction of the serial-type radiation element rows in the fourth group,
the plurality of serial-type radiation element rows in the third group and the plurality of serial-type radiation element rows in the fourth group are arranged in the direction of their rows, and
a region between the plurality of serial-type radiation element rows in the first group and the plurality of serial-type radiation element rows in the second group is disposed between the plurality of serial-type radiation element rows in the third group and the plurality of serial-type radiation element rows in the fourth group.

12. The planar array antenna according to claim 11, wherein
the feed end point is disposed within the region.

13. The planar array antenna according to claim 12, wherein
the parallel feed line is disposed within the region.

14. The planar array antenna according to claim 12, wherein
an entire shape of the plurality of serial-type radiation element rows is line-symmetric with respect to a symmetrical line, the symmetrical line being parallel to the direction of the serial-type radiation element rows in the first group and passing through the feed end point.

15. The planar array antenna according to claim 12, wherein
an entire shape of the plurality of serial-type radiation element rows is line-symmetric with respect to a symmetrical line, the symmetrical line being parallel to the direction of the serial-type radiation element rows in the third group and passing through the feed end point.

16. The planar array antenna according to claim 12, wherein
an entire shape of the plurality of serial-type radiation element rows has four-fold rotational symmetry around the feed end point.

17. The planar array antenna according to claim 5, further comprising
a plurality of amplifiers that are connected to the parallel feed line at a halfway portion thereof from the feed end point to the radiation elements at the ends closest to the feed end point, and amplify signals passing through the parallel feed line.

18. The planar array antenna according to claim 17, wherein
the plurality of amplifiers are disposed at positions that are point-symmetric with respect to the feed end point.

19. A wireless module comprising:
the planar array antenna according to claim 1; and
an electronic component surface-mounted on the planar array antenna, wherein
a feed terminal of the electronic component is connected to the feed end point.
